(19) United States
(12) Patent Application Publication
(10) Pub. No.: US 2011/0125788 A1
(43) Pub. Date: May 26, 2011

(54) METHOD AND APPARATUS FOR REPRESENTING SENSORY EFFECTS AND COMPUTER READABLE RECORDING MEDIUM STORING SENSORY DEVICE CAPABILITY METADATA

(75) Inventors: Sanghyun Joo, Daejon (KR); Bum-Suk Choi, Daejon (KR); Seungsoon Park, Seoul (KR); Hae-Ryong Lee, Daejon (KR); Kwang-Roh Park, Daejon (KR)

(73) Assignee: Electronics and Telecommunications Research Institute, Daejeon (KR)

(21) Appl. No.: 13/054,678

(22) PCT Filed: Jul. 16, 2009
(86) PCT No.: PCT/KR2009/003945

§ 371 Date: Jan. 18, 2011

Related U.S. Application Data
(60) Provisional application No. 61/081,364, filed on Jul. 16, 2008.

(51) Int. Cl. G06F 17/30

(52) U.S. Cl. 707/769; 707/705; 707/E17.014

(57) ABSTRACT

Provided are method and apparatus for representing sensory effects, and a computer readable recording medium storing sensory device capability metadata. A method for providing sensory device capability information includes: obtaining capability information for sensory devices; and generating sensory device capability metadata including the capability information, wherein the sensory device capability metadata includes device capability information that describes the capability information.

### TECHNICAL FIELD

The present invention relates to a method and apparatus for representing sensory effects, and a computer readable recording medium storing sensory device capability metadata.

### BACKGROUND ART

In general, media includes audio and video. The audio may be voice or sound and the video may be a still image and a moving image. When a user consumes or reproduces media, a user uses metadata to obtain information about media. Here, the metadata is data about media. Meanwhile, a device for reproducing media has been advanced from devices reproducing media recorded in an analog format to devices reproducing media recorded in a digital format.

An audio output device such as speakers and a video output device such as a display device have been used to reproduce media.

FIG. 1 is a diagram for schematically describing a media technology according to the related art. As shown in FIG. 1, media is outputted to a user using a media reproducing device 104. The media reproducing device 104 according to the related art include only devices for outputting audio and video. Such a conventional service is referred as a single media single device (SMSD) based service in which one media is reproduced through one device.

Meanwhile, audio and video technologies have been advanced to effectively provide media to a user. For example, an audio technology has been developed to process an audio signal to a multi-channel signal or a multi-object signal or a display technology also has been advanced to process video to a high quality video, a stereoscopic video, and a three dimensional image.

Related to a media technology, a moving picture experts group (MPEG) has introduced MPEG-1, MPEG-2, MPEG-4, MPEG-7, and MPEG-21 and has developed new media concept and multimedia processing technology. MPEG-1 defines a formation for storing audio and video and MPEG-2 defines specification about audio transmission. MPEG-4 defines an object-based media structure. MPEG-7 defines specification about metadata related to media, and MPEG-21 defines media distribution framework technology.

Although realistic experiences can be provided to a user through 3-D audio/video devices due to the development of the media technology, it is very difficult to realize sensory effects only with audio/video devices and media.

### DISCLOSURE

### Technical Problem

An embodiment of the present invention is directed to providing a method and apparatus for representing sensory effects in order to maximize media reproducing effects by realizing sensory effects when media is reproduced.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for providing sensory device capability information, comprising: obtaining capability information for sensory devices; and generating sensory device capability metadata including the capability information, wherein the sensory device capability metadata includes device capability information that describes the capability information.

In accordance with another aspect of the present invention, there is provided an apparatus for providing sensory device capability information, comprising: a controlling unit configured to obtain capability information about sensory devices and to generate sensory device capability metadata including the capability information, wherein the sensory device capability metadata includes device capability information that describes the capability information.

In accordance with another aspect of the present invention, there is provided a method for representing sensory effects, comprising: receiving sensory effect metadata including sensory effect information about sensory effects applied to media; obtaining the sensory effect information by analyzing the sensory effect metadata; receiving sensory device capability metadata including capability information about sensory devices; and generating sensory device command metadata for controlling sensory devices corresponding to the sensory effect information by referring to the capability information included in the sensory device capability metadata, wherein the sensory device capability metadata includes device capability information describing the capability information.

In accordance with another aspect of the present invention, there is provided an apparatus for representing sensory effects, comprising: an input unit configured to receive sensory effect metadata having sensory effect information about sensory effects applied to media and sensory device capability metadata having capability information of sensory devices; a controlling unit configured to obtain the sensory effect information by analyzing the sensory effect metadata and to control sensory devices corresponding to the sensory effect information by referring to the capability information, wherein the sensory device capability metadata includes device capability information that describes the capability information.

In accordance with another aspect of the present invention, there is provided a computer readable recording medium storing metadata, wherein the metadata comprising: sensory device capability metadata having capability information about sensory devices, wherein the sensory device capability metadata includes device capability information that describes the capability information.

### Advantageous Effects

A method and apparatus for reproducing sensory effects can maximize media reproducing effects by realizing sensory effects when media is reproduced.

### BRIEF DESCRIPTION OF THE DRAWINGS

FIG. 1 is a schematic diagram illustrating a media technology according to the related art.

FIG. 2 is a conceptual diagram illustrating realizing sensor effect media in accordance with an embodiment of the present invention.

FIG. 3 is a diagram illustrating a single media multiple device (SMMD) system for representing sensory effects in accordance with an embodiment of the present invention.

FIG. 4 is a diagram illustrating a sensory media generator in accordance with an embodiment of the present invention.

FIG. 5 is a block diagram illustrating an apparatus for representing sensory effects in accordance with an embodiment of the present invention.

FIG. 6 is block diagram illustrating an apparatus for providing sensory device capability information in accordance with an embodiment of the present invention.

FIG. 7 is a block diagram illustrating an apparatus for providing user sensory preference information in accordance with an embodiment of the present invention.

FIG. 8 is a diagram illustrating sensory device capability metadata in accordance with an embodiment of the present invention.

FIG. 9 is a diagram illustrating device capability information (DeviceCapabilities) included in sensory device capability metadata in accordance with an embodiment of the present invention.

FIG. 10 is a diagram illustrating a method for measuring directions and positions of sensory devices in accordance with an embodiment of the present invention.

FIG. 11 is a diagram illustrating device capability common information (DeviceCapCommon) included in sensory device capability metadata in accordance with an embodiment of the present invention.

FIG. 12 is a diagram illustrating current position information (CurrentPosition) included in sensory device metadata in accordance with an embodiment of the present invention.

FIG. 13 is a diagram illustrating direction information (Direction) included in sensory device capability metadata in accordance with an embodiment of the present invention.

FIG. 14 is a diagram illustrating device capability specific information included in sensory device capability metadata in accordance with an embodiment of the present invention.

FIG. 15 is a diagram illustrating LightCapabilities included in sensory device capability metadata in accordance with an embodiment of the present invention.

FIG. 16 is a diagram illustrating FanCapabilities included in sensory device capability metadata in accordance with an embodiment of the present invention.

FIG. 17 is a diagram illustrating TemperatureCapabilities included in sensory device capability metadata in accordance with an embodiment of the present invention.

FIG. 18 is a diagram illustrating VibrationCapabilities included in sensory device capability metadata in accordance with an embodiment of the present invention.

FIG. 19 is a diagram illustrating DiffusionCapabilities included in sensory device capability metadata in accordance with an embodiment of the present invention.

FIG. 20 is a diagram illustrating shading capability (ShadeCapabilities) included in sensory device capability metadata in accordance with an embodiment of the present invention.

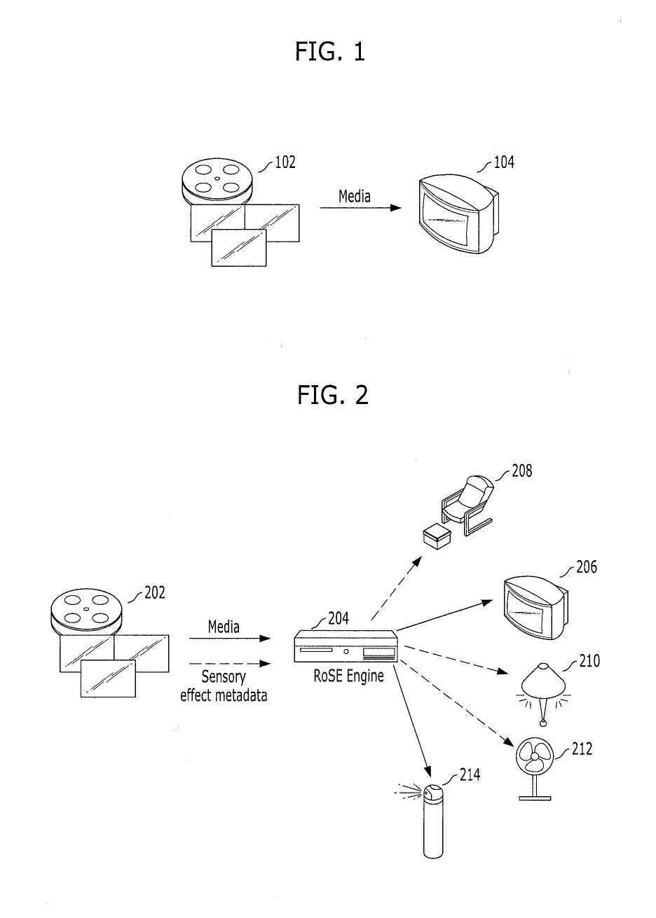

### BEST MODE FOR THE INVENTION

The advantages, features and aspects of the invention will become apparent from the following description of the embodiments with reference to the accompanying drawings, which is set forth hereinafter. In addition, if further detailed description on the related prior arts is determined to obscure the point of the present invention, the description is omitted. Hereafter, preferred embodiments of the present invention will be described in detail with reference to the drawings. The same reference numeral is given to the same element, although the element appears in different drawings.

Conventionally, audio and video are only objects of media generation and consumption such as reproducing. However, human has not only visual and auditory senses but also olfactory and tactile senses. Lately, many studies have been made to develop a device stimulating all of the five senses of human.

Meanwhile, home appliances controlled by an analog signal have been advanced to home appliances controlled by a digital signal.

Media has been limited as audio and video only. The concept of media limited as audio and video may be expanded by controlling devices that stimulate other senses such as olfactory or tactile sense with media incorporated. That is, a media service has been a single media single device (SMSD) based service in which one media is reproduced by one device. However, in order to maximize media reproducing effect in ubiquitous home, a single media multi devices (SMMD) based service may be realized. The SMMD based service reproduces one media through multiple devices.

Therefore, it is necessary to advance a media technology for reproducing media to simply watch and listen to a sensory effect type media technology for representing sensory effects with media reproduced in order to satisfy five senses of human. Such a sensory effect type media may extend a media industry and a market of sensory effect devices and provide rich experience to a user by maximizing media reproducing effect. Therefore, a sensory effect type media may promote the consumption of media.

FIG. 2 is a diagram illustrating realization of sensory effect media in accordance with an embodiment of the present invention.

Referring to FIG. 2, media 202 and sensory effect metadata are input to an apparatus for representing sensory effects. Here, the apparatus for representing sensory effects is also referred as a representation of sensory effect engine (RoSE Engine) 204. Here, the media 202 and the sensory effect metadata may be input to the representation of sensory effect engine (RoSE Engine) 204 by independent providers. For example, a media provider (not shown) may provide media 202 and a sensory effect provider (not shown) may provide the sensory effects metadata.

The media 202 includes audio and video, and the sensory effect metadata includes sensory effect information for representing or realizing sensory effects of media 202. The sensory effect metadata may include all information for maximizing reproducing effects of media 202. FIG. 2 exemplary shows visual sense, olfactory sense, and tactile sense as sensory effects. Therefore, sensory effect information includes visual sense effect information, olfactory sense effect information, and tactile sense effect information.

The RoSE engine 204 receives media 202 and controls a media output device 206 to reproduce the media 202. The RoSE engine 204 controls sensory effect devices 208, 210, 212, and 214 using visual effect information, olfactory effect information, and tactile effect information included in sensory effect metadata. Particularly, the RoSE engine 204 controls lights 210 using the visual effect information, controls a scent device 214 using the olfactory effect information, and controls a trembling chair 208 and a fan 212 using the tactile effect information.

For example, when video including a scene of lightning or thunder is reproduced, lights 210 are controlled to be turned on and off. When video including a scene of foods or a field is reproduced, the scent device 214 is controlled. Further, when video including a scene of water rafting or car chasing is reproduced, the trembling chair 208 and the fan 212 are controlled. Accordingly, sensory effects can be realized corresponding to scenes of video while reproducing.

In order to realize sensory effects, it is necessary to define a schema to express sensory effect information such as intensity of wind, color of light, and intensity of vibration in a standard format. Such a standardized schema for sensory effect information is referred as sensory effect metadata (SEM). When the sensory effect metadata is input to the RoSE engine 204 with the media 202, the RoSE engine 204 analyzes the sensory effect metadata that is described to realize sensory effects at predetermined times while reproducing the media 202. Further, the RoSE engine 204 controls sensory effect devices with being synchronized with the media 202.

The RoSE engine 204 needs to have information about various sensory devices in advance for representing sensory effects. Therefore, it is necessary to define metadata for expressing information about sensory effect devices. Such metadata is referred to as a sensory device capability metadata (SDCap). The sensory device capability metadata includes information about positions, directions, and capabilities of sensory devices.

A user who wants to reproduce media 202 may have various preferences for specific sensory effects. Such preference may influence representation of sensory effects. For example, a user may not like a red color light. Or, when a user wants to reproduce media 202 in the middle of night, the user may want a dim lighting and a low sound volume. By expressing such preferences of a user about predetermined sensory effects as metadata, various sensory effects may be provided to a user. Such metadata is referred to as user sensory preference metadata (USP).

Before representing sensory effects, the RoSE engine 204 receives sensory effect capability metadata from each of sensory effect devices and user sensory preference metadata through an input device or from sensory effect devices. The RoSE engine 204 controls sensory effect devices with reference to the sensory effect capability metadata and the user sensory preference metadata USP. Such a control command is transferred to each of the sensory devices in a form of metadata. The metadata is referred to as a sensory device command metadata (SDCmd).

Hereinafter, a method and apparatus for representing sensory effects in accordance with an embodiment of the present invention will be described in detail.

### DEFINITIONS OF TERMS

### 1. Provider

The provider is an object that provides sensory effect metadata. The provider may also provide media related to the sensory effect metadata.

For example, the provider may be a broadcasting service provider

### 2. Representation of Sensory Effect (RoSE) Engine

The RoSE engine is an object that receives sensory effect metadata, sensory device capabilities metadata, user sensory preference metadata, and generates sensory device commands metadata based on the received metadata.

### 3. Consumer Devices

The consumer device is an object that receives sensory device command metadata and provides sensory device capabilities metadata. Also, the consumer device may be an object that provides user sensory preference metadata. The sensory devices are a sub-set of the consumer devices.

For example, the consumer device may be fans, lights, scent devices, and human input devices such as a television set with a remote controller.

### 4. Sensory Effects

The sensory effects are effects that augment perception by stimulating senses of human at a predetermined scene of multimedia application.

For example, the sensory effects may be smell, wind, and light.

### 5. Sensory Effect Metadata (SEM)

The sensory effect metadata (SEM) defines description schemes and descriptors for representing sensory effects

### 6. Sensory Effect Delivery Format

The sensory effect delivery format defines means for transmitting the sensory effect metadata (SEM).

For example, the sensory effect delivery format may be a MPEG2-TS payload format, a file format, and a RTP payload format.

### 7. Sensory Devices

The sensory devices are consumer devices for producing corresponding sensory effects.

For example, the sensory devices may be light, fans, and heater.

### 8. Sensory Device Capability

The sensory device capability defines description schemes and descriptors for representing properties of sensory devices.

For example, the sensory device capability may be a extensible markup language (XML) schema.

### 9. Sensory Device Capability Delivery Format

The sensory device capability delivery format defines means for transmitting sensory device capability.

For example, the sensory device capability delivery format may be hypertext transfer protocol (HTTP), and universal plug and play (UPnP).

### 10. Sensory Device Command

The sensory device command defines description schemes and descriptors for controlling sensory devices.

For example, the sensory device command may be a XML schema.

### 11. Sensory Device Command Delivery Format

The sensory device command delivery format defines means for transmitting the sensory device command.

For example, the sensory device command delivery format may be HTTP and UPnP.

### 12. User Sensory Preference

The user sensory preference defines description schemes and descriptors for representing user preferences about sensory effects related to rendering sensory effects.

For example, the user sensory preference may be a XML schema.

### 13. User Sensory Preference Delivery Format

The user sensory preference delivery format defines means for transmitting user sensory preference.

For example, the user sensory preference delivery format may be HTTP and UPnP.

### <System for Representing Sensory Effects>

Hereinafter, an overall structure and operation of a system for representing sensory effects in accordance with an embodiment of the present invention will be described in detail.

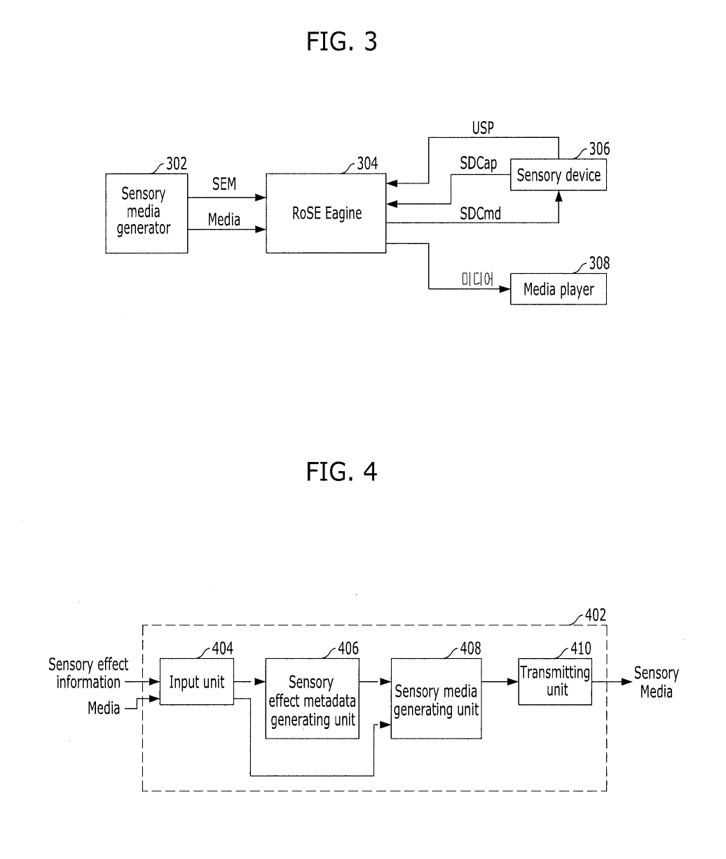

FIG. 3 is a diagram illustrating a single media multiple device (SMMD) system for representing sensory effects in accordance with an embodiment of the present invention.

Referring to FIG. 3, the SMMD system according to the present embodiment includes a sensory media generator 302, a representation of sensory effects (RoSE) engine 304, a sensory device 306, and a media player 308.

The sensory media generator 302 receives sensory effect information about sensory effects applied to media and generates sensory effect metadata (SEM) including the received sensory effect information. Then, the sensory media generator 302 transmits the generated sensory effect metadata to the RoSE engine 304. Here, the sensory media generator 302 may transmit media with the sensory effect metadata.

Although it is not shown in FIG. 3, a sensory media generator 302 according to another embodiment may transmit only sensory effect metadata. Media may be transmitted to the RoSE engine 304 or the media player 308 through additional devices. The sensory media generator 302 generates sensory media by packaging the generated sensory effect metadata with the media and may transmit the generated sensory media to the RoSE engine 304.

The RoSE engine 304 receives sensory effect metadata including sensory effect information about sensory effects applied to media and obtains sensory effect information by analyzing the received sensory effect metadata. The RoSE engine 304 controls the sensory device 306 of a user in order to represent sensory effects while reproducing media using the obtained sensory effect information. In order to control the sensory devices 306, the RoSE engine 304 generate the sensory device command metadata (SDCmd) and transmits the generated sensory device command metadata to the sensory device 306. In FIG. 3, one sensory device 306 is shown for convenience. However, a user may possess a plurality of sensory devices.

In order to generate the sensory device command metadata, the RoSE engine 304 needs information about capabilities of each sensory device 306. Therefore, before generating the sensory device command metadata, the RoSE engine 304 receives sensory device capability metadata (SDCap) that includes the information about capabilities of sensory devices 306. The RoSE engine 304 obtains information about states and capabilities of each sensory device 306 from the sensory device capability metadata. The RoSE engine 304 generates sensory device command metadata for realizing sensory effects that can be realized by each of sensory devices using the obtained information. Here, the controlling the sensory devices include synchronizing the sensory devices with scenes that are reproduced by the media player 308.

In order to control the sensory device 306, the RoSE engine 304 and the sensory device 306 may be connected through networks. Particularly, LonWorks or Universal Plug and Play technologies may be applied as the network technology. In order to effective provide media, media technologies such as MPEG including MPEG-7 and MPEG-21 may be applied together.

A user of the sensory device 306 and the media player 308 may have various preferences about predetermined sensory effects. For example, the user may dislike a predetermined color or may want strong vibration. Such user preference information may be input through the sensory device 306 or an additional input terminal (not shown). Further, the user preference information may be generated in a form of metadata. Such metadata is referred to as user sensory preference metadata USP. The generated user sensory preference metadata is transmitted to the RoSE engine 304 through the sensory device 306 or the input terminal (not shown). The RoSE engine 304 may generate sensory device command metadata in consideration of the received user sensory preference metadata.

The sensory device 306 is a device for realizing sensory effects applied to media. Particularly, the sensory device 306 includes exemplary devices as follows. However, the present invention is not limited thereto.
visual device: monitor, TV, wall screen.
sound device: speaker, music instrument, and bell
   wind device: fan, and wind injector.
   temperature device: heater and cooler
   Lighting device: light, dimmer, color LED, and flash
   shading device: curtain, roll screen, and door
   vibration device: trembling chair, joy stick, and ticker
   scent device: perfumer
   diffusion device: sprayer
other device: devices that produce undefined effects and combination of the above devices

A user may have more than one of sensory devices 306. The sensory devices 306 receive the sensory device command metadata from the RoSE engine 304 and realize sensory effects defined in each scene by synchronizing it with the media.

The media player 308 is a device for reproducing media such as TV. Since the media player 308 is a kind of device for representing video and audio, the media reproduce 308 may be included in the sensory device 306. However, in FIG. 3, the media player 308 is independently shown for convenience. The media player 308 receives media from the RoSE engine 304 or through additional path and reproduces the received media.

### <Method and Apparatus for Generating Sensory Media>

Hereinafter, a method and apparatus for generating sensory media in accordance with an embodiment of the present invention will be described in detail.

The method for generating sensory media according to the present embodiment includes receiving sensory effect information about sensory effects applied to media; and generating sensory effect metadata including the sensory effect information. The sensory effect metadata includes sensory effect description information. The sensory effect description information includes media location information. The media location information describes about locations in media where sensory effects are applied to.

The method for generating sensory media according to the present embodiment further includes transmitting the generated sensory effect metadata to a RoSE engine. The sensory effect metadata may be transmitted as independent data separated from media. For example, when a user requests a movie service, a provider may transmit sensory effect metadata with media data (movie). If a user already has a predetermined media data (movie), a provider may transmit only corresponding sensory effect data applied to the media data.

The method for generating sensory media according to the present invention further includes generating sensory media by packaging the generated sensory effect metadata with media and transmitting the generated sensory media. A provider may generate sensory effect metadata for media, generate sensory media by combining or packaging the generated sensory effect metadata with media, and transmit the generated sensory media to the RoSE engine. The sensory media may be formed of files in a sensory media format for representing sensory effects. The sensory media format may be a file format to be defined as a standard for representing sensory effects.

In the method for generating sensory media according to the present embodiment, the sensory effect metadata includes sensory effect description information that describes sensory effects. The sensory effect metadata further includes general information about generation of metadata. The sensory effect description information includes media location information that shows locations in media where the sensory effects are applied to. The sensory effect description information further includes sensory effect segment information about segments of media. The sensory effect segment information may include effect list information about sensory effects to be applied to segments in media, effect variable information and segment location information representing locations where sensory effects are applied to. The effect variable information may include sensory effect fragment information containing at least one of sensory effect variables that are applied at the same time.

FIG. 4 is a diagram illustrating a sensory media generator in accordance with an embodiment of the present invention.

Referring to FIG. 4, the sensory media generator 402 includes an input unit 404 for receiving sensory effect information about sensory effects applied to media, and a sensory effect metadata generating unit 406 for generating sensory effect metadata including sensory effect information. The sensory effect metadata includes sensory effect description information that describes sensory effects. The sensory effect description information includes media location information that represents locations in media where sensory effects are applied to. The sensory media generator 402 further includes a transmitting unit 410 for transmitting sensory effect metadata to a RoSE engine. Here, the media may be input through the input unit 404 and transmitted to the RoSE engine or a media player through the transmitting unit 410. Alternatively, the media may be transmitted to the RoSE engine or the media player through an additional path without passing through the input unit 404.

Meanwhile, the sensory media generator 402 may further include a sensory media generating unit 408 for generating sensory media by packaging the generated sensory effect metadata with media. The transmitting unit 410 may transmit the sensory media to the RoSE engine. When the sensory media is generated, the input unit 404 receives the media. The sensory media generating unit 408 generates sensory media by combining or packaging the input media from the input unit 404 with the sensory effect metadata generated from the sensory effect metadata generating unit 406.

The sensory effect metadata includes sensory effect description information that describes sensory effects. The sensory effect metadata may further include general information having information about generation of metadata. The sensory effect description information may include media location information that shows locations in media where sensory effects are applied to. The sensory effect description information may further include sensory effect segment information about segments of media. The sensory effect segment information may include effect list information about sensory effects applied to segments of media, effect variable information, and segment location information that shows locations in segments where sensory effects are applied to. The effect variable information includes sensory effect fragment information. The sensory effect fragment information includes at least one of sensory effect variables that are applied at the same time.

### <Method and Apparatus for Representing Sensory Effects>

Hereinafter, a method and apparatus for representing sensory effects in accordance with an embodiment of the present invention will be described in detail.

The method for representing sensory effects according to the present embodiment includes receiving sensory effect metadata including sensory effect information about sensory effects applied to media, obtaining the sensory effect information by analyzing sensory effect metadata; and generating sensory device command metadata to control sensory devices corresponding to the sensory effect information. The method for representing sensory effects according to the present embodiment further includes transmitting the generated sensory effect command metadata to sensory devices. The sensory device command metadata includes sensory device command description information for controlling sensory devices.

The method for representing sensory effects according to the present embodiment further includes receiving sensory device capability metadata. The receiving sensory device capability metadata may further include referring to capability information included in the sensory device capability metadata.

The method for representing sensory effects according to the present embodiment may further include receiving user sensory preference metadata having preference information about predetermined sensory effects. The generating sensory device command metadata may further include referring to the preference information included in user sensory preference metadata.

In the method for representing sensory effects according to the present embodiment, the sensory device command description information included in the sensory device command metadata may include device command general information that includes information about whether a switch of a sensory device is turned on or off, about a location to setup, and about a direction to setup. Further, the sensory device command description information may include device command detail information. The device command detail information includes detailed operation commands for sensory devices.

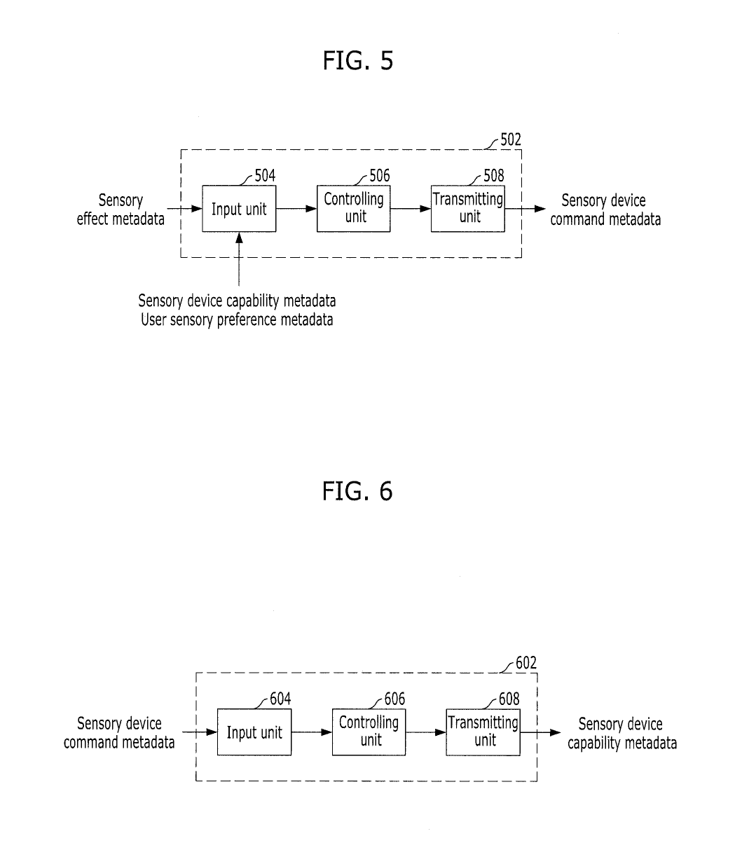

FIG. 5 is a block diagram illustrating an apparatus for representing sensory effects, which is referred to as a representation of sensory effects (RoSE) engine, in accordance with an embodiment of the present invention.

Referring to FIG. 5, the RoSE engine 502 according to the present embodiment includes an input unit 504 for receiving sensory effect metadata having sensory effect information about sensory effects applied to media, and a controlling unit 506 for obtaining sensory effect information by analyzing the received sensory effect metadata and generating sensory effect command metadata to control sensory devices corresponding to the sensory effect information. The sensory device command metadata includes sensory device command description information to control sensory devices. The RoSE engine 502 may further include a transmitting unit 508 for transmitting the generated sensory device command metadata to sensory devices.

The input unit 504 may receive sensory device capability metadata that include capability information about capabilities of sensory devices. The controlling unit 506 may refer to the capability information included in the sensory device capability metadata to generate sensory device command metadata.

The input unit 504 may receive user sensory preference metadata that includes preference information about preferences of predetermined sensory effects. The controlling unit 506 may refer to the preference information included in the user sensory preference metadata to generate the sensory device command metadata.

The sensory device command description information in the sensory device command metadata may include device command general information that includes information about whether a switch of a sensory device is turned on or off, about a location to setup, and about a direction to setup. The sensory device command description information may include device control detail information including detailed operation commands for each sensory device.

### <Method and Apparatus for Providing Sensory Device Capability Information>

Hereinafter, a method and apparatus for providing sensory device capability information in accordance with an embodiment of the present invention will be described in detail.

The method for providing sensory device capability information according to the present embodiment includes obtaining capability information about sensory devices; and generating sensory device capability metadata including the capability information. The sensory device capability metadata includes device capability information that describes capability information. The method for providing sensory device capability information according to the present embodiment may further include transmitting the generated sensory device capability metadata to a RoSE engine.

Meanwhile, the method for providing sensory device capability information according to the present embodiment may further include receiving sensory device command metadata from the RoSE engine and realizing sensory effects using the sensory device command metadata. The RoSE engine generates the sensory effect device command metadata by referring to the sensory device capability metadata.

In the method for providing sensory device capability information according to the present embodiment, the device capability information in the sensory device capability metadata may include device capability common information that include information about locations and directions of sensory devices. The device capability information includes device capability detail information that includes information about detailed capabilities of sensory devices.

FIG. 6 is block diagram illustrating an apparatus for providing sensory device capability information in accordance with an embodiment of the present invention.

The apparatus 602 for providing sensory device capability information may be a device having the same function of a sensory device or may be a sensory device itself. The apparatus 602 may be a stand-alone device independent from a sensory device.

As shown in FIG. 6, the apparatus for providing sensory device capability metadata includes a controlling unit 606 for obtaining capability information about capabilities of sensory devices and generating the sensory device capability metadata including capability information. Here, the sensory device capability metadata includes device capability information that describes capability information. The apparatus for providing sensory device capability information according to the present embodiment further include a transmitting unit 608 for transmitting the generated sensory device capability metadata to the RoSE engine.

The apparatus 602 for providing sensory device capability information may further include an input unit 604 for receiving sensory device command metadata from the RoSE engine. The RoSE engine refers to the sensory device capability metadata to generate the sensory device command metadata. Here, the controlling unit 606 realizes sensory effects using the received sensory device control metadata.

Here, the device capability information included in the sensory device capability metadata may include device capability common information that includes information about locations and directions of sensory devices. The device capability information may include device capability detail information including information about detailed capabilities of sensory devices.

### <Method and Apparatus for Providing User Preference Information>

Hereinafter, a method and apparatus for providing user preference information in accordance with an embodiment of the present invention will be described.

The method for providing user preference information according to the present embodiment includes receiving preference information about predetermined sensory effects from a user, generating user sensory preference metadata including the received preference information. The user sensory preference metadata includes personal preference information that describes preference information. The method for providing user sensory preference metadata according to the present embodiment further includes transmitting the user sensory preference metadata to the RoSE engine.

The method for providing user sensory preference metadata according to the present embodiment may further include receiving sensory device command metadata from a RoSE engine and realizing sensory effects using sensory device command metadata. Here, the RoSE engine refers to the received user sensory preference metadata to generate the sensory device command metadata.

In the method for providing user sensory preference metadata according to the present embodiment, the preference information may include personal information for identifying a plurality of users and preference description information that describes sensory effect preference information of each user. The preference description information may include effect preference information including detailed parameters for at least one of sensory effects.

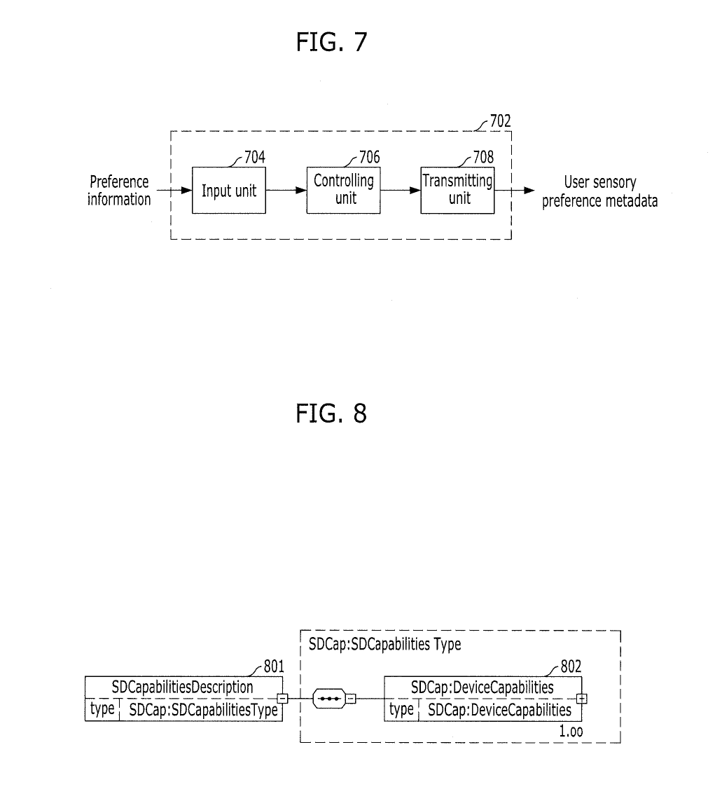

FIG. 7 is a block diagram illustrating an apparatus for providing user sensory preference information in accordance with an embodiment of the present invention.

The apparatus 702 for providing user sensory preference information according to the present embodiment may be a device having the same function of a sensory device or a sensory device itself. Also, the apparatus 702 may be a stand-alone device independent from the sensory device.

As shown in FIG. 7, the apparatus 702 for providing user sensory preference information according to the present embodiment includes an input unit 704 for receiving preference information about predetermined sensory effects from a user and a controlling unit 706 for generating user sensory preference metadata including the received preference information. The user sensory preference metadata includes personal preference information that describes the preference information. The apparatus 702 for providing user sensory preference information according to the present embodiment may further include a transmitting unit 708 for transmitting the generated user sensory preference metadata to the RoSE engine.

The input unit 704 may receive sensory device command metadata from the RoSE engine. The RoSE engine refers to the user sensory preference metadata to generate the sensory device command metadata. The controlling unit 706 may realize sensory effects using the received sensory device command metadata.

The personal preference information included in the user sensory preference metadata includes personal information for identifying each of users and preference description information that describes sensory effect preference of each user. The preference description information may further include effect preference information including detailed parameters about at least one of sensory effects.

### <Sensory Device Capability Metadata>

Hereinafter, sensory device capability metadata according to an embodiment of the present invention will be described in detail.

Sensory device capability information is expressed by commonly applicable elements and device-specific elements. The commonly applicable elements describe controllability and motion ranges related to positions and directions of sensory devices. The device-specific elements are defined for individual sensory devices such as a visual device, a sound device, a wind device, a temperature device, a lighting device, a shading device, a vibration device, and a scent device. Each of the device-specific elements includes sub-elements for controllability, a controllable range, for example, a color range for a lamp, a temperature range of air conditioner, a vibrating range of a trembling chair, a resolution range of an LCD monitor, a scent range for a scent generator, and undefined ranges of sensory devices. A schema for sensory device according to the present embodiment includes an unique device identifier, an effect type to be applied to a device, a device name, a effect rending priority, and an attribute of comment.

The sensory device capability metadata according to the present embodiment may be combined with a media related technology such as MPEG-7 and a network related technology such as LonWorks. As the network related technology such as LonWorks, Standard Network Variable Type (SNVTs) may be used. In this case, a namespace prefix may be used to identify a metadata type. A namespace of the sensory device capability metadata according to the present embodiment is defined as “urn:SDCap:ver1:represent:SensoryDeviceCapabilites:2008-07”. The prefixes for corresponding predetermined namespaces are used for clarification. Table 1 shows prefixes and corresponding name spaces.

TABLE 1

| Prefix | Corresponding namespace |
|---|---|
| SDCap | urn:SDCap:ver1:represent:SensoryDeviceCapabilites:2008-07 |
| Snvt | urn:SNVT:ver1:Represent:VariableList:2007:09 |

Hereinafter, definition and semantics of a schema for sensory device capability metadata in accordance with an embodiment of the present invention will be described in detail.

FIG. 8 is a diagram illustrating sensory device capability metadata in accordance with an embodiment of the present invention.

Referring to FIG. 8, the sensory device capability metadata (SDCap) 801 includes device capability information (DeviceCapabilities) 802. Table 2 shows the device capability information (DeviceCapabilities) 802 in detail.

TABLE 2

| Name | Definition |
|---|---|
| DeviceCapabilities | This element is the container for the device |
| | capabilities. |

The device capability information (DeviceCapabilities) 802 includes information about capabilities of sensory devices.

A schema for the sensory device capability metadata (SDCap) 801 of FIG. 8 is exemplary shown as follows.

| <element | name=“SDCapabilitiesDescription” |
|---|---|
| type=“SDCap:SDCapabilitiesType”/> | |
| <complexType name=“SDCapabilitiesType”> | |
| <sequence> | |
| <element | name=“DeviceCapabilities” |

```
            type=“SDCap:DeviceCapabilitiesType”
            maxOccurs=“unbounded”/>
        </sequence>
    </complexType>
```

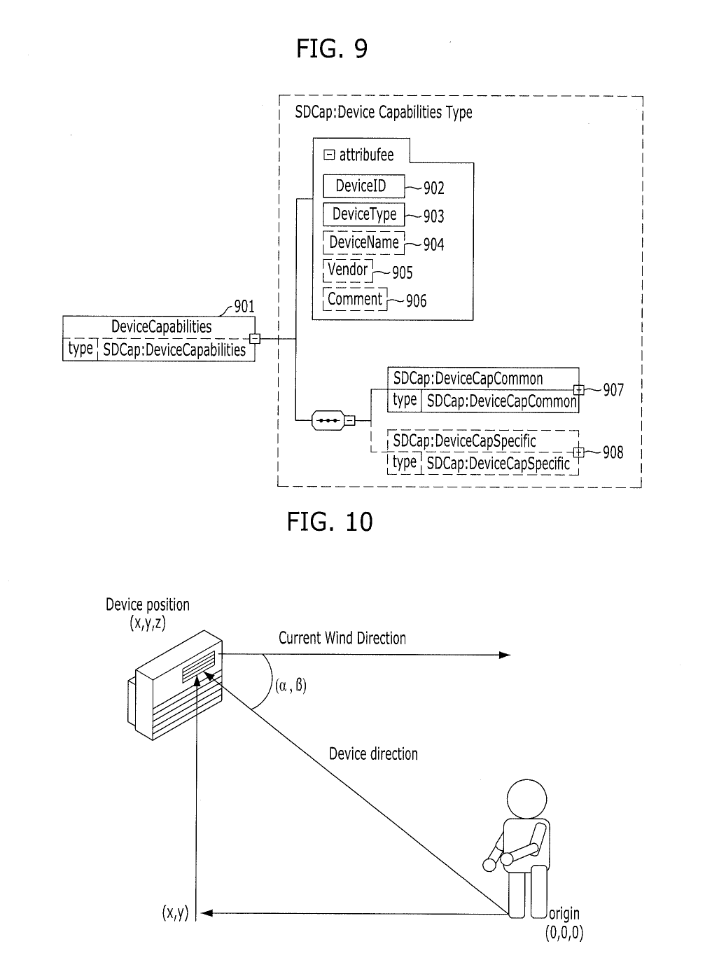

FIG. 9 is a diagram illustrating device capability information (DeviceCapabilities) included in sensory device capability metadata in accordance with an embodiment of the present invention.

The device capability information (DeviceCapabilities) includes a device identifier (DeviceID), a device type (DeviceType), a device name (DeviceName), a vender (Vendor) and a comment (Comments) as attributes related to sensory devices. Further, the device capability information includes two types of element: commonly applicable elements and device-specific elements for describing device capabilities. Referring to FIG. 9, the device capability information (DeviceCapabilities) 901, a device identifier (DeviceID) 902, a device type (DeviceType) 903, a device name (DeviceName) 904, a vender (Vendor) 905, and a comment (Comments) 906. The device capability information (DeviceCapabilities) 901 may include device capability common information (DeviceCapCommon) 907 and device-specific information (DeviceCapSpecific) 908. Table 3 shows these elements of the device capability information in detail.

TABLE 3

| Name | Definition | |
|---|---|---|
| DeviceID | An attribute containing ID of individual Sensory Device | |
| DeviceType | An attribute containing the enumeration set of Sensory Device type | |
| | Enumeration Value | Description |
| | “VisualDevice” | Sensory Device for visualizing |
| | | Ex. monitor, TV, wall screen, etc. |
| | “SoundDevice” | Sensory Device for sound |
| | | Ex. speaker, music instrument, bell |
| | “WindDevice” | Sensory Device for wind |
| | | Ex. fan, wind injector, etc. |
| | “TemperatureDevice” | Sensory Device for controlling temperature |
| | | Ex. heater, cooler |
| | “LightingDevice’ | Sensory Device for emitting light |
| | | Ex. bulb, dimmer, color LED, flash |
| | “ShadingDevice” | Sensory Device for shading light |
| | | Ex. curtain, roll screen, door |
| | “VibrationDevice” | Sensory Device for vibration |
| | | Ex. trembling chair, joystick, tickler |
| | “ScentDevice” | Sensory Device for belching scent |
| | | Ex. perfumer |
| | “DiffusionDevice” | Sensory Device for belching smog or water |
| | | fountain |
| | | Ex. spray |
| | “OtherDevice” | Sensory Device which is undefined or |
| | | combination of above Device type |

| | |
|---|---|
| DeviceName | An attribute containing Device Model |
| Vendor | An attribute containing Vendor's name |
| Comment | An attribute containing additional information |
| DeviceCapComm | An element to describe capabilities commonly applicable to all Sensory Devices |
| on | |
| DeviceCapSpec | An element to describe capabilities applicable to individual Sensory Device |
| ific | |

The device identifier (DeviceID) 902 is an attribute having an identifier (ID) of individual sensory device. As shown in Table 3, the device type (DeviceType) 903 is an attribute having an enumeration set of sensory device types. The device name (DeviceName) 904 is an attribute having a device model name. The vender (Vendor) 905 is an attribute having a name of a device vender. The comment (Comments) 906 is an attribute having additional information.

The device capability common information (DeviceCapCommon) 907 is an element that describes capabilities commonly applicable to all sensory devices. The device capability specific information (DeviceCapSpecific) 908 is an element that describes capabilities applicable to individual sensory device.

A schema for device capability information (DeviceCapabilities) 901 of FIG. 9 is exemplary shown as follows.

| <element | name=“DeviceCapabilities” |
|---|---|
| type=“SDCap:DeviceCapabilitiesType”/> | |
| <complexType name=“DeviceCapabilitiesType”> | |
| <sequence> | |
| <element | name=“DeviceCapCommon” |
| type=“SDCap:DeviceCapCommonType”/> | |
| <element | name=“DeviceCapSpecific” |
| type=“SDCap:DeviceCapSpecificType” | |
| minOccurs=“0”/> | |
| </sequence> | |
| <attribute | name=“DeviceID” type=“ID” |

```
            use=“required”/>
            <attribute name=“DeviceType” use=“required”>
            <simpleType>
                <restriction base=“string”>
                    <enumeration
                    value=“VisualDevice”/>
                    <enumeration value=“SoundDevice”/>
                    <enumeration value=“WindDevice”/>
                    <enumeration
                    value=“TemperatureDevice”/>
                    <enumeration
                    value=“LightingDevice”/>
                    <enumeration
                    value=“ShadingDevice”/>
                    <enumeration
                    value=“VibrationDevice”/>
                    <enumeration value=“ScentDevice”/>
                    <enumeration
                    value=“DiffusionDevice”/>
                    <enumeration value=“OtherDevice”/>
                </restriction>
            </simpleType>
        </attribute>
        <attribute name=“DeviceName” type=“string”/>
        <attribute name=“Vendor” type=“string”/>
        <attribute name=“Comment” type=“string”/>
    </complexType>
```

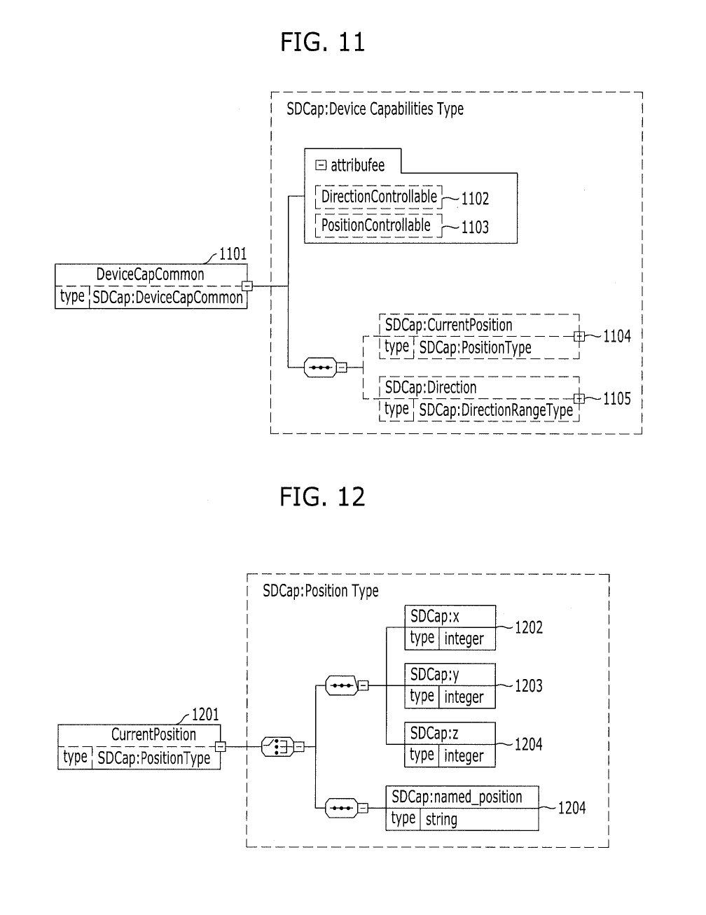

FIG. 10 is a diagram illustrating a method for measuring directions and positions of sensory devices in accordance with an embodiment of the present invention. FIG. 11 is a diagram illustrating device capability common information (DeviceCapCommon) included in sensory device capability metadata in accordance with an embodiment of the present invention.

The device capability common information (DeviceCapCommon) describes capabilities that can be commonly applicable to all of sensory devices. The device capability common information (DeviceCapCommon) includes following elements: controllability, current status, and movable ranges related to a direction and a position. Here, the direction and position can be calculated through the measuring method of FIG. 10. A position of a sensory device is calculated from an origin that is a right tiptoe of a user. A device angle is calculated a horizontal/vertical angle (α, β) between a device direction and a current wind direction.

Referring to FIG. 11, the device capability common information (DeviceCapCommon) 1101 may include direction controllable information (DirectionControllable) 1102 and position controllable information (PositionControllable) 1103. The device capability common information (DeviceCapCommon) 1101 may include current position information (CurrentPosition) 1104 and direction information (Direction) 1105. Table 4 shows these elements of the device capability common information (DeviceCapCommon) 1101 in detail.

TABLE 4

| Name | Definition |
|---|---|
| DirecionContr | This attribute describes if direction of a target |
| ollable | Sensory Device is controllable. |
| PositionConto | This attribute describes if position of a target |
| rollable | Sensory Device is controllable. |
| CurrentPositi | This element describes where a target Sensory Device is. |
| on | |
| Direction | This element describes where a target Sensory Device is |
| | aiming for. |

The direction controllable information (DirectionControllable) 1102 is an attribute describing whether a direction of a target sensory device is controllable. The position controllable information (PositionControllable) 1103 is an attribute describing whether a position of a target sensory device is controllable. The current position information (CurrentPosition) 1104 is an element that describes where a target sensory device is located. The direction information (Direction) 1105 is an element describing where a target sensory device faces toward.

A schema for the device capability common information (DeviceCapCommon) 1101 of FIG. 11 is exemplary shown as follows.

| <element | name=“DeviceCapCommon” |
|---|---|
| type=“SDCap:DeviceCapCommonType”/> | |
| <complexType name=“DeviceCapCommonType”> | |
| <sequence> | |
| <element | ref=“SDCap:CurrentPosition” |
| minOccurs=“0”/> | |
| <element | name=“Direction” |
| type=“SDCap:DirectionRangeType” | |
| minOccurs=“0”/> | |
| </sequence> | |
| <attribute | name=“DirectionControllable” |
| type=“boolean”/> | |
| <attribute | name=“PositionControllable” |
| type=“boolean”/> | |
| </complexType> | |

FIG. 12 is a diagram illustrating current position information (CurrentPosition) included in sensory device metadata in accordance with an embodiment of the present invention.

The current position information (CurrentPosition) is an element describing where a target sensory device is located. A position of a sensory device is expressed by a (x, y, z) coordinate system from a right tiptoe of a user. Alternatively, a position of a sensory device may be simply expressed by a named position given within a list of predetermined values such as front, right, left, and above. Table 5 shows the list of predetermined values and the named positions in detail.

TABLE 5

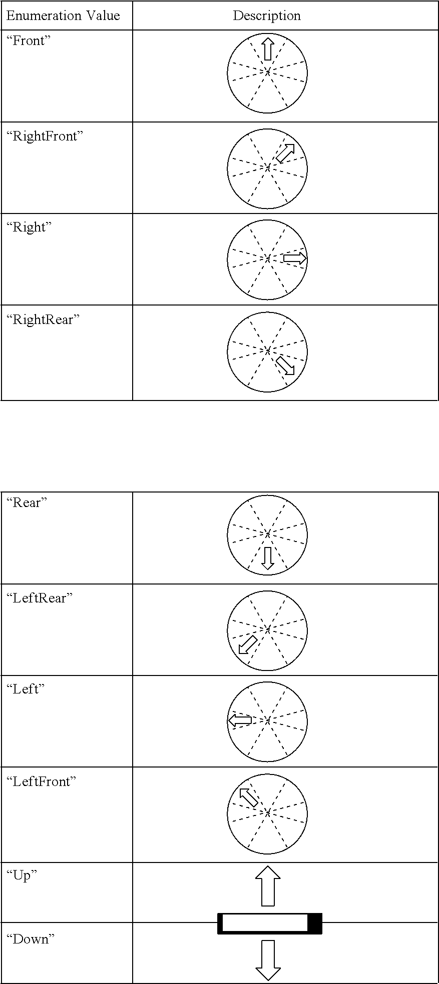

Referring to FIG. 12, the current position information (CurrentPosition) 1201 may include a x-value 1202, a y-value 1203, and a z-value 1204. The current position information (CurrentPosition) 1201 may include named positions (named position) 1205. Table 6 shows these elements in detail.

TABLE 6

| Name | Definition |
|---|---|
| x | x centimeter from a user |
| y | y centimeter from a user |
| z | z centimeter from a user |
| <named_positi | Simple descriptions of Position. |
| on | |

A schema for current position information (CurrentPosition) 1201 of FIG. 12 is exemplary shown as follows.

```
<element name=“CurrentPosition” type=“SDCap:PositionType”/>
    <complexType name=“PositionType”>
        <choice>
            <sequence>
                <element name=“x” type=“integer”/>
                <element name=“y” type=“integer”/>
                <element name=“z” type=“integer”/>
            </sequence>
            <sequence>
                <element name=“named_position”>
                    <simpleType>
                        <restriction base=“string”>
                            <enumeration
                            value=“Front”/>
                            <enumeration
                            value=“RightFront”/>
                            <enumeration
                            value=“Right”/>
                            <enumeration
                            value=“RightRear”/>
                            <enumeration
                            value=“Rear”/>
                            <enumeration
                            value=“LeftRear”/>
                            <enumeration
                            value=“Left”/>
                            <enumeration
                            value=“LeftFront”/>
                            <enumeration
                            value=“Above”/>
                            <enumeration
                            value=“Below”/>
                        </restriction>
                    </simpleType>
                </element>
            </sequence>
        </choice>
    </complexType>
```

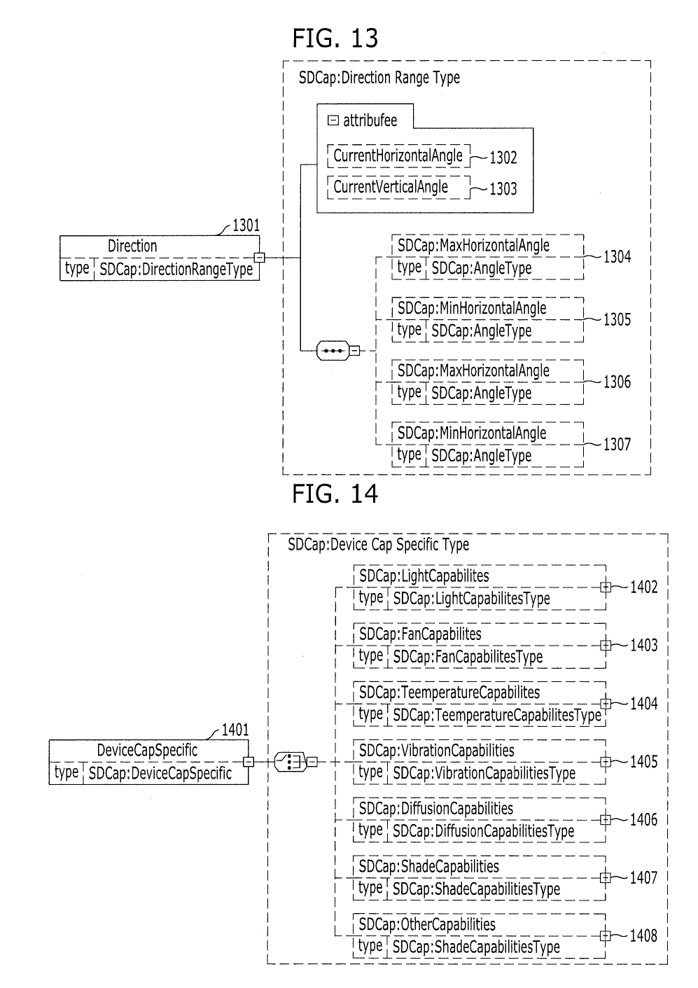

FIG. 13 is a diagram illustrating direction information (Direction) included in sensory device capability metadata in accordance with an embodiment of the present invention.

The direction information (Direction) is an element describing a movable range and a location where a target sensory device faces toward. Referring to FIG. 13, the direction information (Direction) 1301 may include a current horizontal angle (CurrentHorizontalAlgle) 1302 and a current vertical angle (CurrentVerticalAngle) 1303. Further, the direction information (Direction) 1301 may include following elements: a maximum horizontal angle (MaxHorizontalAngle) 1304, a minimum horizontal angle (MinHorizontalAngle) 1305, a maximum vertical angle (MaxVerticalAngle) 1306, and a minimum vertical angle (MinVerticalAngle) 1307. Table 7 shows these elements of the direction information (Direction) 1301 in detail.

TABLE 7

| Name | Definition |
|---|---|
| CurrentHorizo | The attribute describes a current horizontal angel in |
| ntalAngle | degree between a user's right tiptoe and aiming |
| | direction from a Sensory Device. |
| CurrentVertic | The attribute describes a current vertical angel in |
| alAngle | degree between a user's right tiptoe and aiming |
| | direction from a Sensory Device. |
| MaxHorizontal | Maximum movable horizontal angle |
| Angle | |
| MinHorizontal | Minimum movable horizontal angle |
| Angle | |
| MaxVerticalAn | Maximum movable vertical angle |
| gle | |
| MinVerticalAn | Minimum movable vertical angle |
| gle | |

The current horizontal angle CurrentHorizontalAlgle 1302 is an attribute that describes a current horizontal angle as a degree between a right tiptoe of a user and a target aiming direction from a sensory device. The current vertical angle (CurrentVerticalAngle) 1303 is an attribute that describes a degree between a right tiptoe of a user and a target aiming direction from a sensory device. The maximum horizontal angle (MaxHorizontalAngle) 1304 denotes a maximum movable horizontal angle. The minimum horizontal angel (MinHorizontalAngle) 1305 denotes the minimum movable horizontal angle. The maximum vertical angle (MaxVerticalAngle) 1306 is the maximum movable vertical angle. The minimum vertical angle (MinVerticalAngle) 1307 denotes the minimum movable vertical angle.

A schema for the direction information (Direction) 1301 of FIG. 13 is exemplary shown as follows.

| <element name=“Direction” type=“SDCap:DirectionRangeType”/> | |
|---|---|
| <complexType name=“DirectionRangeType”> | |
| <sequence> | |
| <element | name=“MaxHorizontalAngle” |
| type=“SDCap:AngleType” minOccurs=“0”/> | |
| <element | name=“MinHorizontalAngle” |
| type=“SDCap:AngleType” minOccurs=“0”/> | |
| <element | name=“MaxVerticalAngle” |
| type=“SDCap:AngleType” minOccurs=“0”/> | |
| <element | name=“MinVerticalAngle” |
| type=“SDCap:AngleType” minOccurs=“0”/> | |
| </sequence> | |
| <attribute | name=“CurrentHorizontalAngle” |
| type=“SDCap:AngleType”/> | |
| <attribute | name=“CurrentVerticalAngle” |

```
            type=“SDCap:AngleType”/>
    </complexType>
```

FIG. 14 is a diagram illustrating device capability specific information included in sensory device capability metadata in accordance with an embodiment of the present invention.

The device capability specific information (DeviceCapSpecific) is an element that describes applicable capability of individual sensory device such as a lighting device, a fan, a temperature device, a vibration device, and a diffusion device, and a shading device. Referring to FIG. 14, the device capability specific information (DeviceCapSpecific) 1401 may include following elements: a light capability (LightCapabilities) 1402, a fan capability (FanCapabilities) 1403, a temperature capability (TemperatureCapabilities) 1404, a vibration capability (VibrationCapabilities) 1405, a diffusion capability (DiffusionCapabilities) 1406, a shading capability (ShadeCapabilities) 1407, and other capabilities (OtherCapabilities) 1408. Table 8 shows these elements of the device capability specific information (DeviceCapSpecific) in detail.

TABLE 8

| Name | Definition |
|---|---|
| LightCapabilites | This element describes the capabilities for Light |
| | device. |
| FanCapabilites | This element describes the capabilities for Fan |
| | device. |
| TempereatureCapa | This element describes the capabilities for |
| bilites | Tempereature device. |
| VibrationCapabil | This element describes the capabilities for Vibration |
| ites | device. |
| DiffusionCapabil | This element describes the capabilities for Diffusion |
| ites | device. |
| ShadeCapabilites | This element describes the capabilities for Shade |
| | device. |
| Othercapabilites | This element describes the capabilities for other |
| | sensory device. |

The light capability (LightCapabilities) 1402 is an element that describes the capabilities of a lighting device. The fan capability (FanCapabilities) 1403 is an element that describes the capabilities of a fan device. The temperature capability (TemperatureCapabilities) 1404 is an element that describes the capabilities of a temperature device. The vibration capability (VibrationCapabilities) 1405 is an element that describes capabilities for a vibration device. The diffusion capability (DiffusionCapabilities) 1406 is an element describing capabilities for a diffusion device. The shade capability (ShadeCapabilities) 1407 is an element that describes capabilities for a shading device. The other capabilities (OtherCapabilities) 1408 is an element that describes capabilities other sensory devices.

A schema for device capability specific information 1401 of FIG. 14 is exemplary shown as follows.

| <element | name=“DeviceCapSpecific” |
|---|---|
| type=“SDCap:DeviceCapSpecificType”/> | |
| <complexType name=“DeviceCapSpecificType”> | |
| <choice> | |
| <element | name=“LightCapabilites” |
| type=“SDCap:LightCapabilitesType” | |
| minOccurs=“0”/> | |
| <element | name=“FanCapabilites” |
| type=“SDCap:FanCapabilitesType” | |
| minOccurs=“0”/> | |
| <element | name=“TemperatureCapabilites” |
| type=“SDCap:TemperatureCapabilitesType” | |
| minOccurs=“0”/> | |
| <element | name=“VibrationCapabilities” |
| type=“SDCap:VibrationCapabilitesType” | |
| minOccurs=“0”/> | |
| <element | name=“DiffusionCapabilites” |
| type=“SDCap:DiffusionCapabilitesType” | |
| minOccurs=“0”/> | |
| <element | name=“ShadeCapabilites” |
| type=“SDCap:ShadeCapabilitiesType” | |
| minOccurs=“0”/> | |
| <element | name=“OtherCapabilites” |

```
            type=“SDCap:OtherType” minOccurs=“0”/>
        </choice>
    </complexType>
```

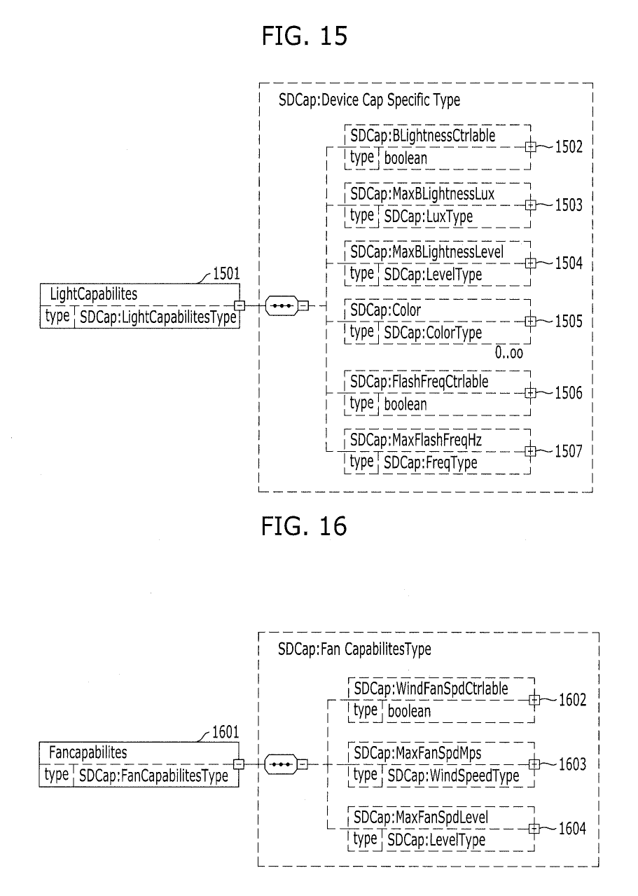

FIG. 15 is a diagram illustrating LightCapabilities included in sensory device capability metadata in accordance with an embodiment of the present invention.

Referring to FIG. 15, LightCapabilities 1501 may include following elements: BrightnessCtrlble 1502, MaxBrightnessLux 1503, MaxBrightnessLevel 1504, Color 1505, FlashFreqCtrlble 1506, and MaxFlashFreqHz 1507. Table 9 shows these elements of LightCapabilities 1501 in detail.

TABLE 9

| Name | Definition |
|---|---|
| BrighnessCtrl | An optional element indicating whether |
| able | brightness is controllabe. The type is Boolean. |
| MaxBrightness | An optional element describing maximum brightness |
| Lux | that a Light Device can act in LUX. |
| | The type is SEM:LuxType. |
| MaxBrightness | An optional element describing maximum brightness |
| Level | that a Light Device can act in level. |
| | The type is SEM:LevelType. |
| Color | An optional element describing the color of the |
| | Sensory Device. In case that the |
| | Sensory Device has mono color such as light |
| | bulb, only one color will be |
| | defined. In other case that the Sensory Device |
| | has multiple colors such as LED, |
| | two or more colors will be defined. The |
| | type of this element is ColorType. |
| | 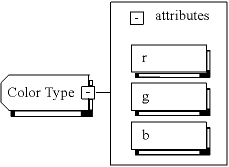 |
| | A particular color is defined by a combination |
| | values of red, green, and blue. |
| FlashFreqCtrl | An optional element indicating whether flickering |
| able | frequency of Flash is controllable. The type is Boolean. |
| MaxFlashFreqH | An optional element defining maximum flickering |
| z | frequency that Flash can act in Hz. |
| | The type is SEM:FreqType. |

BrightnessCtrlble 1502 is an optional element that indicates whether brightness is controllable. The type thereof is Boolean. MaxBrightnessLux 1503 is an optional element that describes the maximum brightness that a light device can emit in LUX unit. A type thereof is LuxType. MaxBrightnessLevel 1504 is an optional element that describes the maximum brightness that a light device can emit in a level unit. A type thereof is LevelType.

Color 1505 is an optional element that describes a color of a sensory device. In case that a sensory device has a mono color like a light bulb, only one color is defined. In case that a sensory device has a plurality of colors like LED, more than two colors are defined. A type of color 1505 is ColorType and has attributes r, g, and b. That is, a predetermined color is defined by combination of a red color, a green color, and a blue color.

FlashFreqCtrlble 1506 is an optional element indicating whether flickering frequency of flash is controllable. A type thereof is Boolean. MaxFlashFreqHz 1507 is an optional element that defines the maximum flickering frequency that Flash can perform in Hz. A type thereof is FreqType.

A schema for LightCapabilities 1501 of FIG. 15 is exemplary shown as follows.

| <element | name=“LightCapabilites” |
|---|---|
| type=“SDCap:LightCapabilitesType”/> | |
| <complexType name=“LightCapabilitesType”> | |
| <sequence> | |
| <element | name=“BrightnessCtrlable” |
| type=“boolean” minOccurs=“0”/> | |
| <element | name=“MaxBrightnessLux” |
| type=“SDCap:LuxType” minOccurs=“0”/> | |
| <element | name=“MaxBrightnessLevel” |
| type=“SDCap:LevelType” minOccurs=“0”/> | |
| <element | name=“Color” type=“SDCap:ColorType” |
| minOccurs=“0” maxOccurs=“unbounded”/> | |
| <element | name=“FlashFreqCtrlable” |
| type=“boolean” minOccurs=“0”/> | |
| <element | name=“MaxFlashFreqHz” |

```
            type=“SDCap:FreqType” minOccurs=“0”/>
        </sequence>
    </complexType>
```

FIG. 16 is a diagram illustrating FanCapabilities included in sensory device capability metadata in accordance with an embodiment of the present invention.

Referring to FIG. 16, the fan capabilities (FanCapabilities) 1601 may include following elements: WindFanSpdCtrlable 1602, MaxFanSpdMps 1603, and MaxFanSpdLevel 1604. Table 10 shows these elements of FanCapabilities 1601 in detail.

TABLE 10

| Name | Definition |
|---|---|
| FanSpdCtrlabl | An optional element indicating whether Fan speed |
| e | is controllable. The type is Boolean. |
| MaxFanSpdMps | An optional element defining maximum speed that |
| | Fan can act in Mps (Meter per second). The type |
| | is SEM:WinSpeedType. |
| MaxfanSpdLeve | An optional element defining maximum speed that |
| l | Fan can act in level. The type is SEM:LevelType. |

WindFanSpdCtrlable 1602 is an optional element that indicates whether a fan speed is controllable. A type thereof is Boolean. MaxFanSpdMps 1603 is an optional element that defines the maximum speed of a fan in meter per second (MPS). A type thereof is WinSpeedType. MaxFanSpdLevel 1604 is an optional element that defines the maximum speed of a fan in a level. A type thereof is LevelType.

A schema for FanCapabilities 1601 of FIG. 16 is exemplary shown as follows.

| <element | name=“FanCapabilites” |
|---|---|
| type=“SDCap:FanCapabilitesType”/> | |
| <complexType name=“FanCapabilitesType”> | |
| <sequence> | |
| <element | name=“WindFanSpdCtrlable” |
| type=“boolean” minOccurs=“0”/> | |
| <element | name=“MaxFanSpdMps” |
| type=“SDCap:WindSpeedType” minOccurs=“0”/> | |
| <element | name=“MaxFanSpdLevel” |

```
            type=“SDCap:LevelType” minOccurs=“0”/>
        </sequence>
    </complexType>
```

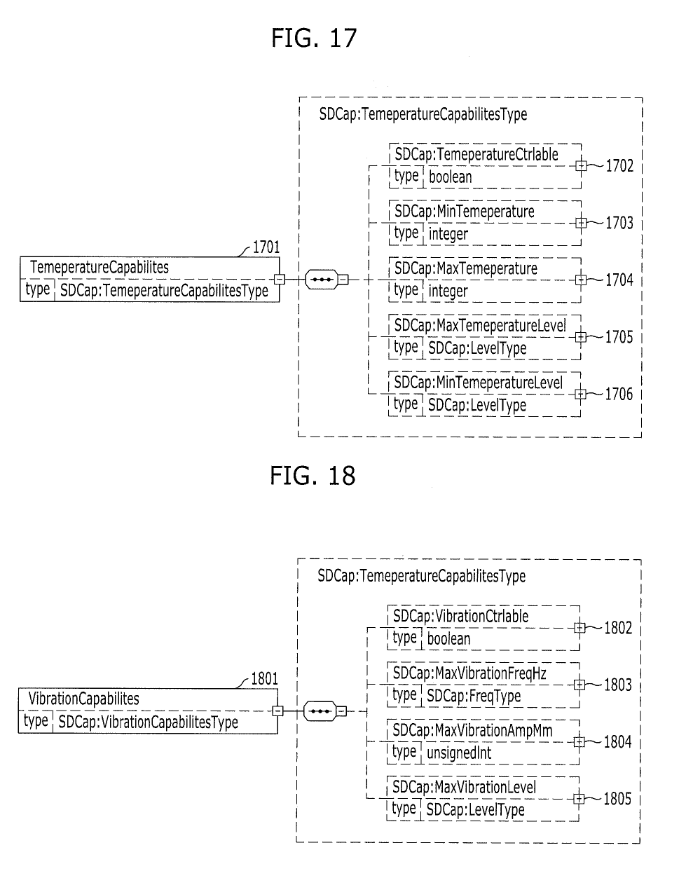

FIG. 17 is a diagram illustrating TemperatureCapabilities included in sensory device capability metadata in accordance with an embodiment of the present invention.

Referring to FIG. 17, TemperatureCapabilities 1701 may include following elements: TemperatureCtrlable 1702, MinTemperature 1703, MaxTemperature 1704, MaxTemperatureLevel 1705, and MinTemperatureLevel 1706. Table 11 shows these elements of TemperatureCapabilities 1701 in detail.

TABLE 11

| Name | Definition |
|---|---|
| TemperatureCt | An optional element indicating whether temperature |
| rlable | is controllable in Celsius. The type is Boolean. |
| MinTemperatur | An optional element defining minimum temperature |
| e | that Sensory Device can act in Celsius |
| MaxTemperatur | An optional element defining maximum temperature |
| e | that Sensory Device can act in Celsius |
| MaxTermperatu | An optional element defining maximum temperature |
| reLevel | controlling level |
| MinTemperatur | An optional element defining minimum temperature |
| elevel | controlling level |

TemperatureCtrlable 1702 is an optional element indicating whether temperature is controllable in Celsius. A type thereof is Boolean. MinTemperature 1703 is an optional element defining the minimum temperature of a sensory device in Celsius. MaxTemperature 1704 is an optional element defining the maximum temperature of a sensory device in Celsius. MaxTemperatureLevel 1705 is an optional element defining the maximum temperature controlling level. MinTemperatureLevel 1706 is an optional element that defines the minimum temperature controlling level.

A schema for TemperatureCapabilities 1701 of FIG. 17 is exemplary shown as follows.

| <element | name=“TemperatureCapabilites” |
|---|---|
| type=“SDCap:TemperatureCapabilitesType”/> | |
| <complexType name=“TemperatureCapabilitesType”> | |
| <sequence> | |
| <element | name=“TemperatureCtrlable” |
| type=“boolean” minOccurs=“0”/> | |
| <element | name=“MinTemperature” type=“integer” |
| minOccurs=“0”/> | |
| <element | name=“MaxTemperature” type=“integer” |
| minOccurs=“0”/> | |
| <element | name=“MaxTemperatureLevel” |
| type=“SDCap:LevelType” minOccurs=“0”/> | |
| <element | name=“MinTemperatureLevel” |

```
            type=“SDCap:LevelType” minOccurs=“0”/>
        </sequence>
    </complexType>
```

FIG. 18 is a diagram illustrating VibrationCapabilities included in sensory device capability metadata in accordance with an embodiment of the present invention.

Referring to FIG. 18, VibrationCapabilities 1801 may include following elements: VibrationCtrlable 1802, MaxVibrationFreqHz 1803, MaxVibrationAmpMm 1804, and MaxVibrationLevel 1805. Table 12 shows these elements of VibrationCapabilities 1801 in detail.

TABLE 12

| Name | Definition |
|---|---|
| VibrationCtrl | An optional element indicating whether vibration |
| able | frequency is controllable. The type is Boolean. |
| MaxVibrationF | An optional element defining maximum frequency |
| reqHz | that vibration device can act in Hz. The type is |
| | SEM:FreqType. |
| MaxVibrationA | An optional element defining maximum amplitude |
| mpMm | that vibration device can act in Millimeter. The |
| | type is unsigned integer. |
| MaxVibrationL | An optional element defining max intensity level |
| evel | that vibration device can act. The type is |
| | SEM:LevelType. |

VibrationCtrlable 1802 is an optional element indicating whether vibration frequency is controllable. A type thereof is Boolean. MaxVibrationFreqHz 1803 is an optional element that defines the maximum frequency of a vibration device in Hz. A type thereof is FreqType. MaxVibrationAmpMm 1804 is an optional element that defines maximum amplitude of a vibration device in millimeter. A type thereof is an unsigned integer. MaxVibrationLevel 1805 is an optional element defining the maximum intensity level that vibration device can perform. A type thereof is LevelType.

A scheme for VibrationCapabilities 1801 of FIG. 18 is exemplary shown as follows.

| <element | name=“VibrationCapabilites” |
|---|---|
| type=“SDCap:VibrationCapabilitesType”/> | |
| <complexType name=“VibrationCapabilitesType”> | |
| <sequence> | |
| <element | name=“VibrationCtrlable” |
| type=“boolean” minOccurs=“0”/> | |
| <element | name=“MaxVibrationFreqHz” |
| type=“SDCap:FreqType” minOccurs=“0”/> | |
| <element | name=“MaxVibrationAmpMm” |
| type=“unsignedInt” minOccurs=“0”/> | |
| <element | name=“MaxVibrationLevel” |

```
            type=“SDCap:LevelType” minOccurs=“0”/>
        </sequence>
</complexType>
```

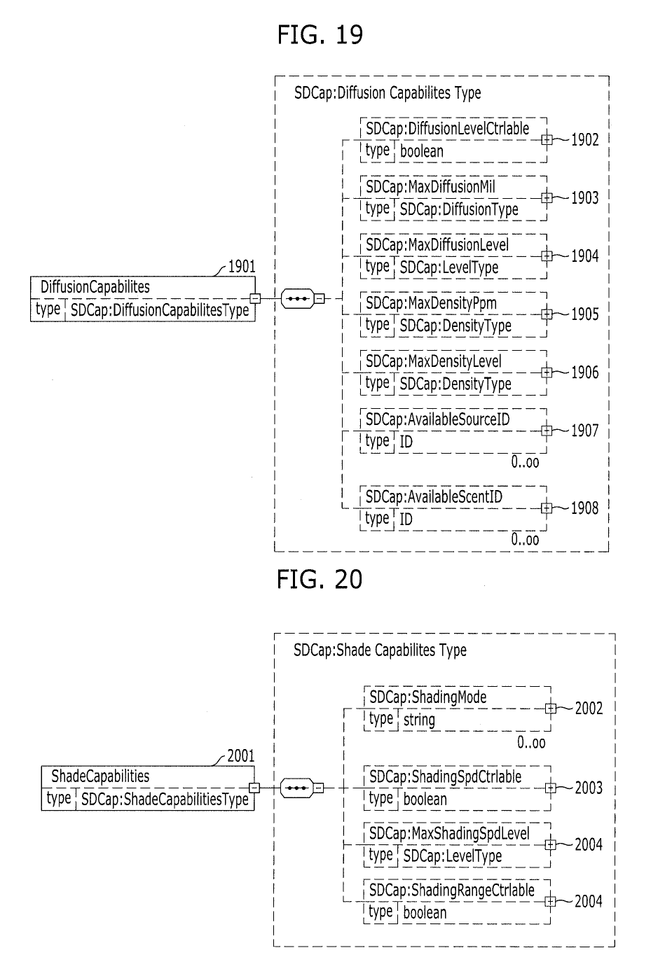

FIG. 19 is a diagram illustrating DiffusionCapabilities included in sensory device capability metadata in accordance with an embodiment of the present invention.

Referring to FIG. 19, DiffusionCapabilities 1901 may include following elements: DiffusionLevelCtrlable 1902, MaxDiffusionMil 1903, MaxDiffusionLevel 1904, MaxDensityPpm 1905, MaxDensityLevel 1906, AvailableSourceID 1907, and AvailableScentID 1908. Table 13 shows these elements of DiffusionCapabilities 1901 in detail.

TABLE 13

| Name | Definition |
|---|---|
| DiffusionLeve | An optional element indicating whether diffusion |
| lCtrlable | level is controllable. |
| MaxDiffusionM | An optional element defining maximum quantity |
| il | that diffusion device can act in Milligram |
| MaxDiffusionL | An optional element defining maximum level that |
| evel | diffusion device can act |
| MaxDensityPpm | An optional element defining maximum density |
| | that diffusion device can act in Ppm |
| MaxDensityLev | An optional element defining maximum density |
| el | level that diffusion device can act |
| AvailableSour | An optional element defining source ID that a |
| ceID | diffusion device has. A diffusion device may have |
| | multiple sources |
| AvailableScen | An optional element defining scent ID that a scent |
| tID | device has. A scent device may have multiple sources |

DiffusionLevelCtrlable 1902 is an optional element indicating whether a diffusion level is controllable or not. MaxDiffusionMil 1903 is an optional element that defines a maximum quantity that a diffusion device can act in milligram. MaxDiffusionLevel 1904 is an optional element that defines a maximum density that a diffusion device can provide. MaxDensityPpm 1905 is an optional element defining a maximum density that a diffusion device can represent in a unit of ppm. MaxDensityLevel 1906 is an optional element defining a maximum density level that a diffusion device acts. AvailableSourceID 1907 is an optional element defining a source ID of a diffusion device. A diffusion device may have a plurality of sources. AvailableScentID 1908 is an optional element defining a scent ID of a scent device. A scent device may have a plurality of sources.

A schema for DiffusionCapabilities 1901 of FIG. 19 is exemplary shown as follows.

| <element | name=“DiffusionCapabilites” |
|---|---|
| type=“SDCap:DiffusionCapabilitesType”/> | |
| <complexType name=“DiffusionCapabilitesType”> | |
| <sequence> | |
| <element | name=“DiffusionLevelCtrlable” |
| type=“boolean” minOccurs=“0”/> | |
| <element | name=“MaxDiffusionMil” |
| type=“SDCap:DiffusionType” minOccurs=“0”/> | |
| <element | name=“MaxDiffusionLevel” |
| type=“SDCap:LevelType” minOccurs=“0”/> | |
| <element | name=“MaxDensityPpm” |
| type=“SDCap:DensityType” minOccurs=“0”/> | |
| <element | name=“MaxDesityLevel” |
| type=“SDCap:LevelType” minOccurs=“0”/> | |
| <element | name=“AvailableSourceID” type=“ID” |
| minOccurs=“0” maxOccurs=“unbounded”/> | |
| <element | name=“AvailableScentID” type=“ID” |

```
            minOccurs=“0” maxOccurs=“unbounded”/>
        </sequence>
    </complexType>
```

FIG. 20 is a diagram illustrating shading capability (ShadeCapabilities) included in sensory device capability metadata in accordance with an embodiment of the present invention.

Referring to FIG. 20, the shading capability (ShadeCapabilities) 2001 may include following elements: ShadingMode 2002, ShadingSpdCtrlable 2003, MaxhadingSpdLevel 2004, and ShadingRangeCtrlable 2005. Table 14 shows these elements of the shading capability 2001 in detail.

TABLE 14

| Name | Definition | |
|---|---|---|
| ShadingMode | An optional element having enumeration set of the | |
| | shading mode of Sensory Device | |
| | Enumeration Value | Description |
| | “SideOpen” | Curtain type |
| | “Roll Open” | Roll screen type |
| | “PullOpen” | Pull door type |
| | “PushOpen” | Push door type |

| | |
|---|---|
| ShadingSpdCtr | An optional element indicating whether shading |
| lable | speed is controllable. |
| MaxShadingSpd | An optional element defining maximum shading |
| Level | speed level that a shading device can act. |
| ShadingRangeC | An optional element indicating whether shading |
| trlable | range is controllable. |

ShadingMode 2002 is an optional element having an enumeration set of a shading mode of a sensory device. Table 14 shows shading modes corresponding to enumeration values. ShadingSpdCtrlable 2003 is an optional element indicating whether a shading speed is controllable. MaxhadingSpdLevel 2004 is an optional element defining the maximum shading speed level that a shading device can act. ShadingRangeCtrlable 2005 is an optional element indicating whether a shading range is controllable.

A schema of ShadeCapabilities 2001 of FIG. 20 is exemplary shown as follows.

| | |
|---|---|
| <element | name=“ShadeCapabilities” |

```
type=“SDCap:ShadeCapabilitiesType”/>
    <complexType name=“ShadeCapabilitiesType”>
        <sequence>
```

| | |
|---|---|
| <element | name=“ShadingMode” minOccurs=“0” |

```
            maxOccurs=“unbounded”>
                <simpleType>
                    <restriction base=“string”>
                        <enumeration
                        value=“SideOpen”/>
                        <enumeration
                        value=“RollOpen”/>
                        <enumeration
                        value=“PullOpen”/>
                        <enumeration
                        value=“PushOpen”/>
                    </restriction>
                </simpleType>
            </element>
```

| | |
|---|---|
| <element | name=“ShadingSpdCtrlable” |

type=“boolean” minOccurs=“0”/>

| | |
|---|---|
| <element | name=“MaxShadingSpdLevel” |

type=“SDCap:LevelType” minOccurs=“0”/>

| | |
|---|---|
| <element | name=“ShadingRangeCtrlable” |

```
                type=“boolean” minOccurs=“0”/>
    </sequence>
    </complexType>
```

Table 15 describes simple type in detail. It is necessary to restrict an intensity value of sensory effect for safety purpose. In the present embodiment, a simple type for each sensory effect measurement unit is defined and it is referred in user sensory preference metadata.

TABLE 15

| Name | Definition & Source |
|---|---|
| LuxType | This simple type represents degree of brightness using lux. The restriction base |
| | is the snvt:luxType. The value is restricted from 0 to 5000 lux. |
| | <simpleType name=“LuxType”> |
| | <restriction base=“snvt:luxType”> |
| | <maxInclusive value=“5000”/> |
| | </restriction> |
| | </simpleType> |
| AngleType | This simple type represents the dregree of the angle. The restriction base is the |
| | snvt:angle_degType. The value is restricted from −359.9 to 360. |
| | <simpleType name=“AngleType”> |
| | <restriction base=“snvt:angle degType”> |
| | <minInclusive value=“−359.9”/> |
| | <maxInclusive value=“360.0”/> |
| | </restriction> |
| | </simpleType> |
| TemperatureType | This simple type represents the temperature using centigrade. The restriction |
| | base is the snvt:temp pType. The value is restricted from 0 to 45. |
| | <simpleType name=“TemperatureType”> |
| | <restriction base=“snvt:temp_pType”> |
| | <minInclusive value=“−15”/> |
| | <maxInclusive value=“45”/> |
| | </restriction> |
| | </simpleType> |
| VibrationType | This simple type represents the intensity of vibration using rpm. The restriction |
| | base is the snvt:rpm Type. The value is restricted from 0 to 20000. |
| | <simpleType name=“VibrationType”> |
| | <restriction base=“snvt:rpm_Type”> |
| | <maxInclusive value=“20000”/> |
| | </restriction> |
| | </simpleType> |
| WindSpeedType | This simple type represents speed of wind using meter per second. The |
| | restriction base is the snvt:speed_milType. The value is restricted from |
| | 0 to 20. |
| | <simpleType name=“WindSpeedType”> |
| | <restriction base=“snvt:speed_milType”> |
| | <maxInclusive value=“20”/> |
| | </restriction> |
| | </simpleType> |
| DensityType | This simple type represents the density of the diffusion source using parts per |
| | million. The restriction base is the snvt:ppmType. |
| | <simpleType name=“DensityType”> |
| | <restriction base=“snvt:ppmType”/> |
| | </simpleType> |
| DiffusionType | This simple type represents diffusion. The restriction base is the |
| | snvt:mass_milType. The value is restricted from 0 to 20000. |
| | <simpleType name=“DiffusionType”> |
| | <restriction base=“snvt:mass_milType”> |
| | <maxInclusive value=“200”/> |
| | </restriction> |
| | </simpleType> |
| | <minInclusive value=“0”/> |
| | <maxInclusive value=“10”/> |
| | </restriction> |
| | </simpleType> |
| DiffusionType | This simple type represents mass using milligram. The restriction base is |
| | snvt:mass_milType. The value is restricted from 0 to 200. |
| | <simpleType name=“DiffusionType”> |
| | <restriction base=“snvt:mass_milType”> |
| | <maxInclusive value=“200”/> |
| | </restriction> |
| | </simpleType> |
| DensityType | This simple type represents density using ppm. The restriction base is |
| | snvt:ppmType. The value is restricted from 0 to 10000. |
| | <simpleType name=“DensityType”> |
| | <restriction base=“snvt:ppmType”> |
| | <maxInclusive value=“10000”/> |
| | </restriction> |
| | </simpleType> |
| LevelType | This simple type represents percentage. The value is restricted from 0 to 100. |
| | <simpleType name=“LevelType”> |
| | <restriction base=“unsignedInt”> |
| | <minInclusive value=“0”/> |
| | <maxInclusive value=“100”/> |
| | </restriction> |
| | </simpleType> |
| VibrationType | This simple type represents intensity of vibration using rpm. The restriction base |
| | is snvt:rmp Type. The value is restricted from 0 to 20000. |
| | <simpleType name=“VibrationType”> |
| | <restriction base=“snvt:rpm_Type”> |
| | <maxInclusive value=“20000”/> |
| | </restriction> |
| | </simpleType> |

Hereinafter, a definition and semantic of a SNVT schema related to LonWorks will be described.

LonWorks provides an open networking platform formed of a protocol designed by Echelon Corporation for networking devices connected through twisted pairs, power lines and fiber optics. LonWorks defines (1) a dedicated microprocessor known as an neuron chip which is highly optimized for devices on control network, (2) a transceiver for transmitting protocols on predetermined media such as twisted pairs or power lines, (3) a network database which is an essential software component of an open control system (which is also known as LNS network operating system), and (4) internet connection with standard network variable types (SNVTs). One of elements for interoperability in LonWorks is the standardization of SNVTs. For example, a thermostat using temperature SNVT has values between 0 to 65535 which are equivalent to a temperature range of −274° C. to 6279.5° C. DRESS media is rendered through devices that can be controlled by media metadata for special effect. A metadata schema for describing special effects may be designed based on a restricted set of SNVT data type for device control. Table 16 shows SNVT expression in LonWorks.

TABLE 16
SNVT_angle_deg (104)
Phase/Rotation

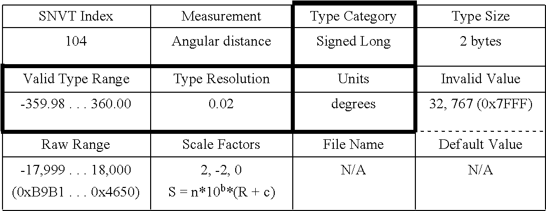

In Table 16, boxes surrounded with a bold line are translated to a XML schema. The box Type Category expresses a variable type using predefined variable types such as unsignedInt, float, decimal and Boolean. The box Valid type Range limits a range of values and the box Type Resolution defines a resolution to express a value. The box Units denotes a unit to express a SNVT type. In case of SNVT_angle_deg, a proper unit thereof is degrees.

Table 17 describes SNVTs translated to XML schema.

TABLE 17

| SNVT | Definition | | | |
|---|---|---|---|---|
| SNVT_lux | SNVT_lux describes illumination using lux. The type of SNVT_lux is snvt:luxType. | | | |
| | The following table is provided in LonMark web site. | | | |
| | Illumination (luminous-flux intensity) | | | |
| | 1 lux = 1 lumen · m² | | | |
| | As a comparison: 1 foot-candle = 1 lumen/ft². 1 foot-candle = 10.76 lux. | | | |
| | SNVT Index | Measurement | Type Category | Type Size |
| | 79 | Illumination | Unsigned Long | 2 bytes |
| | Valid Type Range | Type Resolution | Units | Invalid Value |
| | 0 . . . 65,335 | 1 | Lux | |
| | Raw Range | Scale Factors | File Name | Default Value |
| | 0 . . . 65,535 | 1, 0, 0 | N/A | N/A |
| | (0 . . . 0xFFFF) | S = a * 10^{b} * (R + c) | | |
| | According to the definition, we design snvt:luxType. | | | |
| | <simpleType name=“luxType”> | | | |
| | <restriction base=“unsignedInt”> | | | |
| | <minInclusive value=“0”/> | | | |
| | <maxInclusive value=“65534”/> | | | |
| | </restriction> | | | |
| | </simpleType> | | | |
| SNVT_speed_mil | SNVT_speed_mi\|describes linear velocity as m/s(meters/sec). The type of | | | |
| | SNVT_speed_mil is snvt:speed_milType. | | | |
| | Linear Velocity | | | |
| | SNVT Index | Measurement | Type Category | Type Size |
| | 35 | Linear Velocity | Unsigned Long | 2 bytes |
| | Valid Type Range | Type Resolution | Units | Invalid Value |
| | 0 . . . 65,535 | 0.001 | Meters per Second | |
| | | | (m/s) | |
| | Raw Range | Scale Factors | File Name | Default Value |
| | 0 . . . 65,535 | 1, −3, 0 | N/A | N/A |
| | (0 . . . 0xFFFF) | S = a * 10^{b} * (R + c) | | |
| | According to the definition, we design snvt:speed_milType. | | | |
| | <simpleType name=“speed_milType”> | | | |
| | <restriction base=“float”> | | | |
| | <minInclusive value=“0”/> | | | |
| | <maxInclusive value=“65,535”/> | | | |
| | <fractionDigits value=“3”/> | | | |
| | </restriction> | | | |
| | </simpleType> | | | |
| SNVT_angle_deg | SNVT_angle_deg describes degree for phase and rotation. The type of | | | |
| | SNVT_angle_deg is snvt:angle_degType. | | | |
| | Phase/Rotation | | | |
| | SNVT Index | Measurement | Type Category | Type Size |
| | 104 | Angular distance | Signed Long | 2 bytes |
| | Valid Type Range | Type Resolution | Units | Invalid Value |
| | −359.98 . . . 360.00 | 0.02 | degrees | 32,767 (0x7FFF) |
| | Raw Range | Scale Factors | File Name | Default Value |
| | −17,999 . . . 18,000 | 2, −2, 0 | N/A | N/A |
| | (0xB9B1 . . . 0x4650) | S = n * 10^{b} * (R + c) | | |
| | <simpleType name=“temp_pType”> | | | |
| | <restriction base=“decimal”> | | | |
| | <minInclusive value=“−273,17”/> | | | |
| | <maxInclusive value=“327,66”/> | | | |
| | <fractionDigits value=“2”/> | | | |
| | </restriction> | | | |
| | </simpleType> | | | |
| SNVT_rpm | SNVT_rpm describes angular velocity with rotation per minutes. The type of | | | |
| | SNVT_rpm is snvtrpm_Type. | | | |
| | Angular Velocity | | | |
| | SNVT Index | Measurement | Type Category | Type Size |
| | 102 | Angular Velocity | Unsigned Long | 2 bytes |
| | Valid Type Range | Type Resolution | Units | Invalid Value |
| | 0 . . . 65,534 | 1 | Revolutions per | 65,535 (0xFFFF) |
| | | | Minute (RPM) | |
| | Raw Range | Scale Factors | File Name | Default Value |
| | 0 . . . 65,534 | 1, 0, 0 | N/A | N/A |
| | (0 . . . 0xFFFE) | S = a * 10^{b} * (R + c) | | |

```
According to the definition, we design snvt:rpm_Type.
<simpleType name=“rpm_Type”>
  <restriction base=“unsignedInt”>
    <minInclusive value=“0”/>
    <maxInclusive value=“65534”/>
  </restriction>
</simpleType>
```

The present application contains a subject matter related to U.S. Patent Application No. 61/081,364, filed in the United States Patent and Trademark Office on Jul. 16, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A method for providing sensory device capability information, comprising:
obtaining capability information for sensory devices; and
generating sensory device capability metadata including the capability information,
wherein the sensory device capability metadata includes device capability information that describes the capability information.

2. The method of claim 1, further comprising: transmitting the sensory device capability metadata to an apparatus for representing sensory effects.

3. The method of claim 2, further comprising:
receiving sensory device command metadata from the apparatus for representing sensory effects; and
realizing sensory effects using the sensory device command metadata.

4. The method of claim 1, wherein the device capability information includes device capability common information that includes position information and direction information of the sensory devices.

5. The method of claim 1, wherein the device capability information device capability detail information including information about detailed capabilities of the sensory devices.

6. An apparatus for providing sensory device capability information, comprising:
a controlling unit configured to obtain capability information about sensory devices and to generate sensory device capability metadata including the capability information,
wherein the sensory device capability metadata includes device capability information that describes the capability information.

7. The apparatus of claim 6, wherein device capability common information including position information and direction information of the sensory devices.

8. The apparatus of claim 6, wherein the device capability information includes device capability detail information including information about detailed capabilities of the sensory devices.

9. A method for representing sensory effects, comprising:
receiving sensory effect metadata including sensory effect information about sensory effects applied to media;
obtaining the sensory effect information by analyzing the sensory effect metadata;
receiving sensory device capability metadata including capability information about sensory devices; and
generating sensory device command metadata for controlling sensory devices corresponding to the sensory effect information by referring to the capability information included in the sensory device capability metadata,
wherein the sensory device capability metadata includes device capability information describing the capability information.

10. The method of claim 9, wherein the device capability information includes device capability common information including position information and direction information of the sensory devices.

11. The method of claim 9, wherein the device capability information including device capability detail information having information about detailed capabilities of the sensory devices.

12. An apparatus for representing sensory effects, comprising:
an input unit configured to receive sensory effect metadata having sensory effect information about sensory effects applied to media and sensory device capability metadata having capability information of sensory devices;
a controlling unit configured to obtain the sensory effect information by analyzing the sensory effect metadata and to control sensory devices corresponding to the sensory effect information by referring to the capability information,
wherein the sensory device capability metadata includes device capability information that describes the capability information.

13. The apparatus of claim 12, wherein the device capability information includes device capability common information having position information and direction information of the sensory devices.

14. The apparatus claim 12, wherein the device capability information includes device capability detail information having information about detailed capabilities of the sensory devices.

15. A computer readable recording medium storing metadata, wherein the metadata comprising:
sensory device capability metadata having capability information about sensory devices,
wherein the sensory device capability metadata includes device capability information that describes the capability information.
